(19) United States
(12) Patent Application Publication
(10) Pub. No.: US 2025/0289198 A1
(43) Pub. Date: Sep. 18, 2025

(54) METHOD FOR OBTAINING A CASCADE OF VANES OF AN AIRCRAFT THRUST REVERSAL DEVICE FROM TUBULAR PREFORMS, CASCADE OF VANES OBTAINED USING THIS METHOD

(71) Applicants: Airbus SAS, BLAGNAC (FR); Airbus Operations SAS, TOULOUSE (FR)

(72) Inventors: Emeric CHANCERELLE, ROCHEFORT (FR); Gautier DESTOMBES, ROCHEFORT (FR); Julie CAZALIS, TOULOUSE (FR); Sébastien BONNET, ROCHEFORT (FR)

(21) Appl. No.: 19/078,970

(22) Filed: Mar. 13, 2025

(30) Foreign Application Priority Data
Mar. 15, 2024 (FR) FR2402591

(51) Int. Cl. B29D 99/00; F02K 1/62

(52) U.S. Cl. CPC B29D 99/0025; F02K 1/62; F05D 2220/323; F05D 2230/60

(57) ABSTRACT

A method for obtaining a cascade of vanes of an aircraft thrust reversal device by: manufacturing tubular preforms each having transverse and longitudinal facets that form a single piece, delimit a cell of the cascade of vanes and constitute at least one layer of the vanes, and longitudinal walls of the cascade of vanes situated around the cell; assembling the tubular preforms by connecting the transverse facets of the two tubular preforms so as to form a common vane, and/or the longitudinal facets of two tubular preforms so as to form a segment of a common longitudinal wall. Also a cascade of vanes obtained using such a method.

### CROSS-REFERENCES TO RELATED APPLICATIONS

This application claims the benefit of French Patent Application Number FR2402591 filed on Mar. 15, 2024, the entire disclosure of which is incorporated herein by way of reference.

### FIELD OF THE INVENTION

The present application relates to a method for obtaining a cascade of vanes of an aircraft thrust reversal device from tubular preforms, to a cascade of vanes obtained using this method and also to an aircraft comprising at least one such cascade of vanes.

### BACKGROUND OF THE INVENTION

According to an embodiment visible in FIGS. 1 to 3, an aircraft 10 comprises a plurality of propulsion assemblies 12 positioned beneath each of the wings 14 of the aircraft 10 and connected to the latter by pylons 16. Each propulsion assembly 12 comprises a motor 18 positioned inside a nacelle 20. The motor 18 comprises a fan that has an axis of rotation A18.

For the remainder of the description, a longitudinal direction is parallel to the axis of rotation A18. A longitudinal plane is a plane containing the axis of rotation A18 and a transverse plane is a plane perpendicular to the axis of rotation A18. The concepts of front/upstream and rear/downstream refer to the direction of flow of an air stream in the nacelle 20, this stream flowing from the front (upstream) to the rear (downstream).

The nacelle 20 has an approximately tubular shape and delimits, with the motor 18, an annular duct 22 in which a secondary air stream flows. The nacelle 20 comprises an upstream section 24 referred to as the air intake, a median section 26 in which the fan of the motor 18 is positioned, and a downstream section 28 that has a trailing edge 30.

The nacelle 20 comprises a thrust reversal device 34 positioned in the downstream section 28 and configured to occupy an activated state in which it deflects, outward and upstream of the nacelle 20, at least a part of the secondary air stream circulating in the annular duct 22, and an inactivated state in which it does not deflect the secondary air stream circulating in the annular duct 22.

The thrust reversal device 34 comprises at least one mobile part 36 that makes it possible to create at least one lateral opening 38 (visible in FIG. 2) passing through the nacelle 20.

The thrust reversal device 34 comprises a deflection system 40 configured to occupy a retracted position, when the thrust reversal device 34 is in the inactivated state, in which the deflection system 40 does not interfere with the secondary air stream, and a deployed position, when the thrust reversal device 34 is in the activated state, in which the deflection system 40 interferes with the secondary air stream and orients it toward the lateral opening 38.

The thrust reversal device 34 also comprises an orientation system 42 configured to orient the air stream deflected by the deflection system 40. According to one embodiment, the orientation system 42 comprises a plurality of cascades of vanes 44 positioned at each lateral opening 38.

According to an embodiment visible in FIGS. 4 and 5, each cascade of vanes 44 has longitudinal walls 46 positioned in approximately longitudinal planes, and vanes 48 positioned in approximately transverse planes. The longitudinal walls 46 and the vanes 48 delimit cells 50.

The vanes 48 have a profile for deflecting upstream the air stream leaving via each lateral opening 38. To this end, each vane 48 is curved and has a depth P, as illustrated in FIG. 5.

According to one arrangement, the cascade of vanes 44 comprises five longitudinal walls 46 delimiting four rows of vanes 48, sixteen vanes 48 for each row and seventy-two cells 50.

Given their geometry and in particular the shallow depth P of the vanes 48, the cascades of vanes 44 have a large number of cells 50 and therefore a relatively large mass, and this is detrimental in terms of on-board mass and energy consumption for an aircraft.

As illustrated in FIGS. 6 and 7, a cascade of vanes 44 is made of composite material by molding, using for each cell 50 a core 52 that is configured to expand.

According to one operating mode, a method for obtaining a cascade of vanes 44 comprises a step of stacking plies of fibers so as to obtain first preforms 46′, one for each longitudinal wall 46, and second preforms 48′, one for each vane 48. As illustrated in FIG. 6, the first preforms 46′ are substantially planar. The second preforms 48′ have an H-shaped section provided with first and second flanges 48.1′, 48.2′ at each end, which are intended to be pressed against first preforms 46′.

The method for obtaining a cascade of vanes 44 comprises, for each row of vanes, a step of putting in place, alternating them, second preforms 48′ and cores 52 between two first preforms 46′ that are substantially parallel to each other, the first flanges 48,1′ of all the second preforms 48′ being pressed against the first preform 46′ situated on the left, the second flanges 48,2′ of all the second preforms 48′ being pressed against the first preform 46′ situated on the right. When all the first and second preforms 46′, 48′ are positioned, the obtaining method comprises a consolidation or polymerization step, for connecting the first and second preforms 46′, 48′ to each other, during which the assembly is compressed and subjected to an increase in temperature.

The rise in temperature causes expansion of the cores 52, which compress the second preforms 48′. After the consolidation or polymerization step, the cascade of vanes 44 obtained and the cores 52 are cooled, and this causes the cores 52 to shrink. The obtaining method then comprises a demolding step during which the cores 52 are extracted from the cascade of vanes 44.

Given the relatively shallow depth P of the vanes 48, the cores 52 compress them correctly during the consolidation or polymerization step, and this makes it possible to control the structural integrity of the cascade of vanes 44 obtained.

This obtaining method, which is designed for vanes with a shallow depth, is not suitable if the vanes have a great depth, the cores not expanding sufficiently to compress the preforms. Moreover, the larger the dimensions of the core, the more complex it is to control the deformation thereof. In the presence of vanes having a great depth, it is necessary to provide relatively complex slide cores that are difficult, or even impossible, to extract.

### SUMMARY OF THE INVENTION

The present invention aims to remedy all or some of the drawbacks of the prior art.

To this end, one subject of the invention is a method for obtaining a cascade of vanes of an aircraft thrust reversal device, said cascade of vanes having at least first and second longitudinal walls and vanes positioned between said first and second longitudinal walls and connected to the latter, the longitudinal walls and the vanes delimiting cells.

According to the invention, the obtaining method comprises:
a step of manufacturing at least first and second tubular preforms each having a first transverse facet forming at least one layer of a first vane, a second transverse facet forming at least one layer of a second vane, a first longitudinal facet forming at least one layer of a first longitudinal wall and a second longitudinal facet forming at least one layer of a second longitudinal wall; the first and second transverse facets and the first and second longitudinal facets forming a single piece and delimiting a cell,
a step of assembling the first and second tubular preforms, consisting in or comprising of connecting:
   the first and second transverse facets of the first and second tubular preforms so as to form a common vane, and/or
   the first and second longitudinal facets of the first and second tubular preforms so as to form a segment of a common longitudinal wall.

According to the invention, a cascade of vanes is obtained from a multitude of tubular preforms, one for each cell, which are each manufactured using relatively simple tooling that ensures the structural integrity of said preforms. This makes it possible to obtain, after a step of assembling said preforms, a cascade of vanes that has excellent mechanical properties and vanes with, for at least some of them, a relatively great depth.

According to another feature, the manufacturing step comprises, for at least one tubular preform, at least one phase of compression of said tubular preform and at least one curing or polymerization phase during which said tubular preform is compressed and at least partially cured or polymerized.

According to another feature, prior to the compression phase, the manufacturing step comprises, for at least one tubular preform, a draping phase during which plies of fibers are positioned on or against at least one mold that has first, second, third and fourth inner faces respectively shaped like the first transverse and longitudinal facets and also the second transverse and longitudinal facets.

According to another feature, the compression phase consists in using at least one expandable element configured to occupy retracted and expanded states, in positioning it in the retracted state between the various facets of a tubular preform positioned in the mold and in expanding the expandable element so as to compress said tubular preform.

According to another feature, the plies of fibers are positioned on the first, second, third and fourth inner faces when the mold has a tubular shape, by alternating first plies of fibers each disposed only alongside one of the first, second, third and fourth inner faces and also second, corner plies of fibers disposed straddling two inner faces among the first, second, third and fourth inner faces.

According to another feature, the mold comprises a plurality of parts configured to occupy assembled and disassembled states. In addition, first plies of fibers each disposed only alongside one of the first, second, third and fourth inner faces are positioned when the parts of the mold are in the disassembled state.

According to another feature, the step of assembling first and second tubular preforms consists in pressing against one another and connecting the first and second transverse facets of the first and second tubular preforms so as to form a vane, and in aligning the first longitudinal facets of the first and second tubular preforms so as to form at least a part of the first longitudinal wall and the second transverse facets of the first and second tubular preforms so as to form at least a part of the first longitudinal wall.

According to another feature, at least some vanes each comprise a body and a flange substantially perpendicular to the body. In addition, the first transverse facet extends over at least a part of a vane at the body and the flange thereof, the second transverse facet extending over at least a second part of a vane at the body and the flange thereof, the first and second parts being complementary such that when they are assembled the first transverse facet of a first tubular preform and the second transverse facet of a second tubular preform form a complete vane.

According to another feature, the method for obtaining a cascade of vanes comprises a step of manufacturing at least one longitudinal preform forming a layer of a longitudinal wall and a step of assembling the longitudinal preform and the tubular preforms.

According to another feature, two tubular preforms are connected by at least one ply of adhesive and/or at least one ply of fibers interposed between the two tubular preforms.

According to another feature, during the manufacturing step, each tubular preform is partially cured or polymerized, a final curing or polymerization phase being carried out subsequently, at the latest during the assembly step.

According to another feature, during the manufacturing step, each tubular preform is completely cured or polymerized.

Another subject of the invention is a cascade of vanes obtained using an obtaining method according to one of the preceding features, and also an aircraft comprising at least one such cascade of vanes.

### BRIEF DESCRIPTION OF THE DRAWINGS

Further features and advantages will become apparent from the following description of the invention, which description is given solely by way of example, with reference to the appended drawings in which:

FIG. 1 is a perspective view of an aircraft and a propulsion assembly, illustrating one embodiment,

FIG. 2 is a side view of a propulsion assembly, illustrating an embodiment of the prior art,

FIG. 3 is a schematic cross section of a propulsion assembly equipped with a thrust reversal device in the inactivated state, illustrating an embodiment of the prior art,

FIG. 4 is a perspective view of a cascade of vanes, illustrating an embodiment of the prior art,

FIG. 5 is a longitudinal cross section on the plane P-V of the cascade of vanes visible in FIG. 4,

FIG. 6 is a schematic depiction of a step of putting in place longitudinal walls, vanes and cores, illustrating an embodiment of the prior art,

FIG. 7 is a top view of a cascade of vanes during a consolidation or polymerization step, illustrating an embodiment of the prior art,

FIG. 8 is a perspective view of a cascade of vanes, illustrating an embodiment of the invention,

FIG. 9 is a longitudinal cross section on the plane P-IX of the cascade of vanes visible in FIG. 8,

FIG. 10 is a perspective view of a vane, illustrating an embodiment of the invention,

FIG. 11 is a longitudinal cross section of tooling and of a tubular preform, illustrating an embodiment of the invention,

FIG. 12 is a cross section on a median surface of tooling and of a tubular preform, illustrating an embodiment of the invention,

FIG. 13 is a cross section on a median surface of tooling and of a tubular preform, illustrating another embodiment of the invention,

FIG. 14 is a perspective view of tubular preforms before an assembly step, illustrating an embodiment of the invention,

FIG. 15 is a perspective view of the tubular preforms visible in FIG. 14 after an assembly step,

FIG. 16 is a schematic cross section on a median surface of an assembly of a plurality of tubular preforms, illustrating an embodiment of the invention,

FIG. 17 is a longitudinal cross section of a part of an assembly of tubular preforms, illustrating an embodiment of the invention,

FIG. 18 is a perspective view of a part of a cascade of vanes before an assembly step, illustrating an embodiment of the invention,

FIG. 19 is a schematic cross section on a median surface of an assembly of a plurality of tubular preforms, illustrating an embodiment of the invention,

FIG. 20 is a schematic depiction of a cascade of vanes at various moments of an assembly step, illustrating an embodiment of the invention.

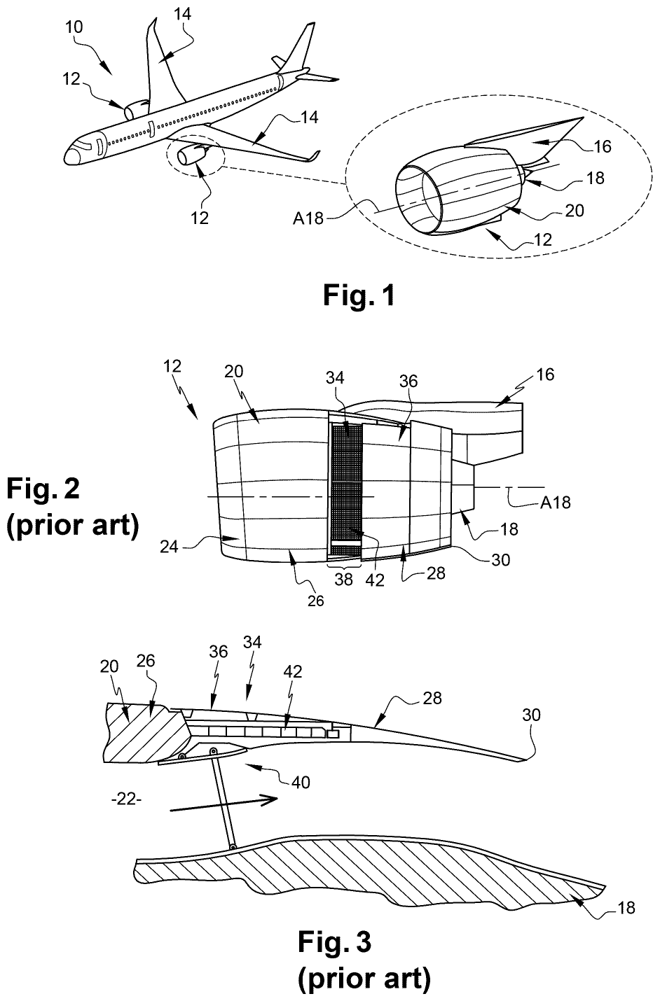

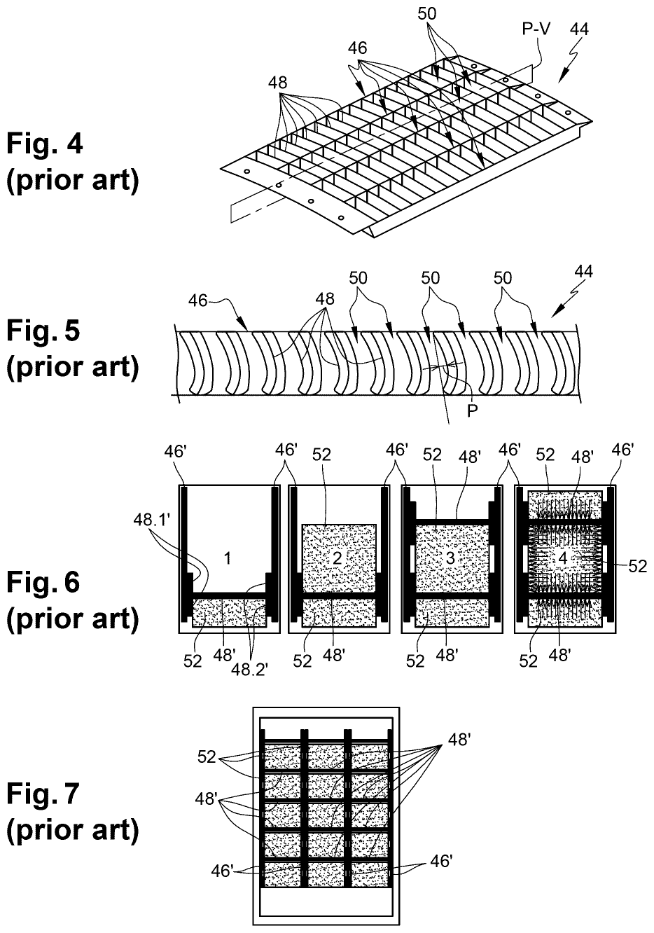

### DETAILED DESCRIPTION OF THE PREFERRED EMBODIMENTS

According to one application, an aircraft comprises at least one thrust reversal device that has at least one cascade of vanes 60.

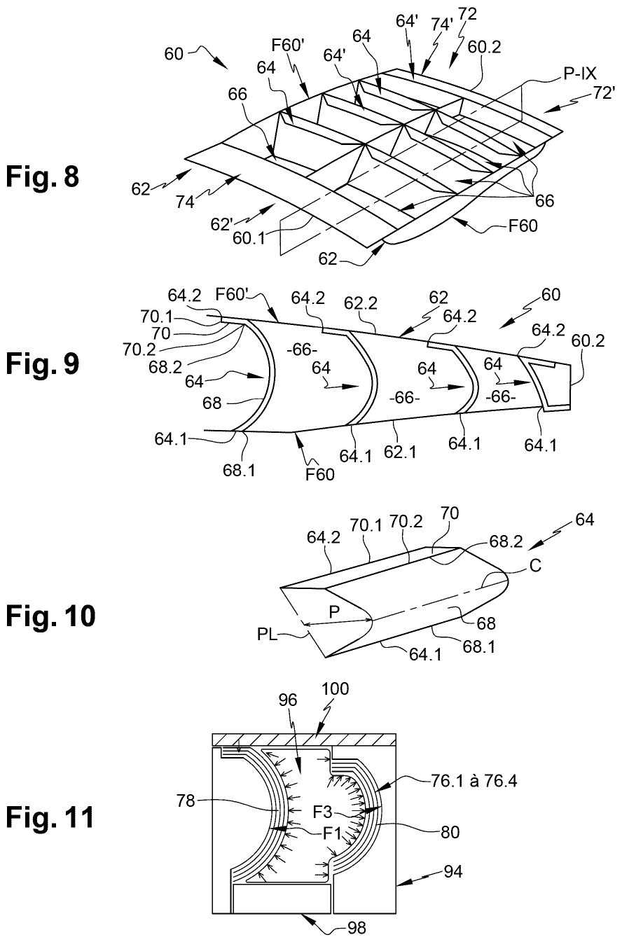

According to an embodiment visible in FIGS. 8 and 10, a cascade of vanes 60 has at least first and second longitudinal walls 62, 62′ positioned in approximately longitudinal planes and vanes 64, 64′ positioned between said first and second longitudinal walls 62, 62′, connected to the latter and positioned in approximately transverse planes; the longitudinal walls 62, 62′ and the vanes 64, 64′ delimiting cells 66.

Each longitudinal wall 62, 62′ extends between inner and outer edges 62.1, 62.2. Each vane 64, 64′ extends between inner and outer edges 64.1, 64.2. According to one arrangement, the inner edges 62.1, 64.1 of the longitudinal walls 62, 62′ and of the vanes 64, 64′ are positioned at a first surface forming an inner surface F60 of the cascade of vanes 60, the outer edges 62.2, 64.2 of the longitudinal walls 62, 62′ and of the vanes 64, 64′ being positioned at a second surface forming an outer surface F60′ of the cascade of vanes 60. According to one configuration, the inner and outer surfaces F60, F60′ are curved so as to match the curvature of a nacelle. Of course, the invention is not limited to this geometry for the inner and outer surfaces F60, F60′.

A median surface is a surface substantially parallel to the inner and outer surfaces F60, F60′, situated between said inner and outer surfaces F60, F60′.

The vanes 64, 64′ have inner and outer edges 64.1, 64.2 that are substantially parallel to each other and oriented in a transverse direction substantially perpendicular (i.e., +/−10%) to the longitudinal direction.

According to one configuration, each vane 64, 64′ has a substantially constant section in the transverse direction. The vanes 64, 64′ may have identical sections. As a variant, as illustrated in FIG. 9, the vanes 64, 64′ have different sections from one vane to another.

According to an embodiment visible in FIG. 10, at least some vanes 64 each comprise a body 68 that extends between a first edge 68.1, corresponding to the inner edge 64.1 of the vane 64, and a second edge 68.2 and also a flange 70 situated in the extension of the body 68 that extends between a first edge 70.1, corresponding to the outer edge 64.2 of the vane 64, and a second edge 70.2 as one with the second edge 68.2 of the body 68. In a longitudinal plane, the flange 70 is substantially perpendicular to the body 68. For each vane 64, the body 68 and the flange 70 form just a single piece.

According to one configuration, the flange 70 is substantially planar and situated at the outer surface F60′ of the cascade of vanes 60.

The vane 64 has a depth P that corresponds to a maximum distance separating a plane PL passing through the inner and outer edges 64.1, 64.2 of the vane 64 and a generatrix C of the body 68 that is furthest from the plane PL.

According to one configuration, the depth P of the vane 64 is relatively great. Relatively great is understood to mean that the depth P does not make it possible to correctly compress a preform intended to form a vane using simple cores according to a method of the prior art visible in FIGS. 6 and 7.

According to one arrangement, the cascade of vanes 60 comprises three longitudinal walls 62, 62′ defining two rows of vanes 72, 72′, and four vanes 64, 64′ per row of vanes, the longitudinal walls 62 and the vanes delimiting eight cells 66.

Given the depth P of the vanes 64, 64′, it is possible to reduce their number, and this tends to reduce the mass of the cascade of vanes 60.

Generally, a cascade of vanes 60 comprises a plurality of rows of vanes 72, 72′. However, a cascade of vanes 60 could comprise only a single row of vanes 72.

Whatever the embodiment, the cascade of vanes 60 comprises longitudinal end walls corresponding to the longitudinal walls 62 that are furthest apart. It extends between a front end 60.1 situated approximately in a first transverse plane and a rear end 60.2 situated approximately in a second transverse plane.

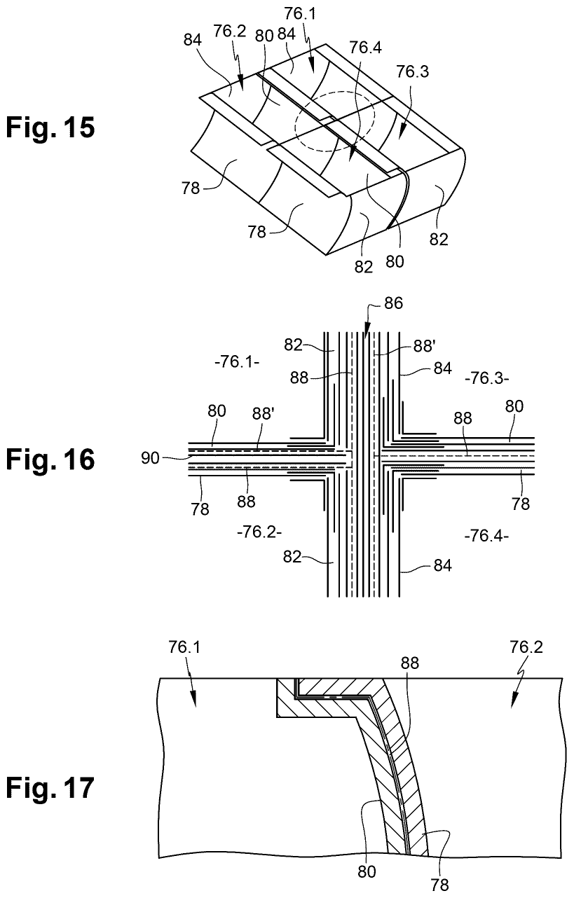

According to one embodiment, the cascade of vanes 60 comprises at least one end plate 74 situated at the front or rear end 60.1, 60.2, connecting the longitudinal end walls and positioned at the outer surface F60′ of the cascade of vanes 60. According to a configuration visible in FIGS. 14 and 15, each end plate 74 is a substantially rectangular strip of material that has long sides substantially parallel to the transverse direction. At least one end plate 74 comprises at least one through-orifice 74.1 configured to fasten the cascade of vanes 60 to a structure of an aircraft.

According to one arrangement, the cascade of vanes 60 comprises two end plates 74, 74′ positioned at the front and rear ends 60.1, 60.2 of the cascade of vanes 60.

As illustrated in FIGS. 11 to 20, a method for obtaining a cascade of vanes 60 comprises:
a step of manufacturing at least first and second tubular preforms 76.1, 76.2 each having a first transverse facet 78 forming at least one layer of a first vane 64, a second transverse facet 80 forming at least one layer of a second vane 64′, a first longitudinal facet 82 forming at least one layer of a first longitudinal wall 62 and a second longitudinal facet 84 forming at least one layer of a second longitudinal wall 62′; the first and second transverse facets 78, 80 and the first and second longitudinal facets 82, 84 forming a single piece and delimiting a cell 66,
a step of assembling the first and second tubular preforms 76.1, 76.2, consisting in pressing against one another and connecting:
   the first and second transverse facets 78, 80 of the first and second tubular preforms 76.1, 76.2 so as to form a common vane 64, and/or
   the first and second longitudinal facets 82, 84 of the first and second tubular preforms 76.1, 76.2 so as to form a segment of a common longitudinal wall 62.

According to one embodiment, the step of assembling the first and second tubular preforms 76.1, 76.2 consists in pressing against one another and connecting the first and second transverse facets 78, 80 of the first and second tubular preforms 76.1, 76.2 so as to form a vane 64, and in aligning the first longitudinal facets 82 of the first and second tubular preforms 76.1 to 76.2 so as to form at least a part of the first longitudinal wall 62 and the second transverse facets 84 of the first and second tubular preforms 76.1 to 76.2 so as to form at least a part of the first longitudinal wall 62.

According to one configuration, the first and second longitudinal facets 82, 84 each extend from the inner edge 62.1 as far as the outer edge 62.2 of a longitudinal wall 62, 62′. As a variant, the first longitudinal facet 82 extends over a first part of a longitudinal wall 62 and the second longitudinal facet 84 extends over a second part of a longitudinal wall 62, the first and second parts being complementary such that the first longitudinal facet 82 of a first tubular preform 76.1 and the second longitudinal facet 84 of a second tubular preform 76.2 form a segment of a longitudinal wall 62, 62′.

According to one configuration, each of the first and second transverse facets 78, 80 extends at the body 68 and the flange 70 of a vane 64. Thus, as illustrated in FIGS. 11 and 17, the first transverse facet 78 forms a first part of the body 68 and of the flange 70 of a vane 64 and the second transverse facet 80 forms a second part of the body 68 and of the flange 70 of a vane 64, the first and second parts being complementary such that the first transverse facet 78 of a first tubular preform 76.1 and the second transverse facet 80 of a second tubular preform 76.2 form a complete vane 64.

According to another configuration, only the first transverse facet 78 extends at the flange 70 of a vane. According to this configuration, the second transverse facet 80 extends only at the body 68 of the vane 64.

Whatever the configuration, the first transverse facet 78 extends over at least a part of a vane 64 and the second transverse facet 80 extends over at least a second part of a vane 64 that is complementary to the first part such that, when they are assembled, the first transverse facet 78 of a first tubular preform 76.1 and the second transverse facet 80 of a second tubular preform 76.2 form a complete vane 64.

According to a first operating mode, when a cascade of vanes 60 comprises a plurality of rows of vanes, the tubular preforms of the various rows are assembled during one and the same assembly step, as illustrated in FIGS. 14 and 15.

According to a second operating mode, as illustrated in FIG. 20, when a cascade of vanes 60 comprises a plurality of rows of vanes, the assembly step comprises a first phase of assembling each row, consisting in connecting the tubular preforms 76.1 to 76.4 so as to form the rows of vanes independently of one another, then a second phase of assembling the various rows of vanes, consisting in connecting the rows of vanes to each other.

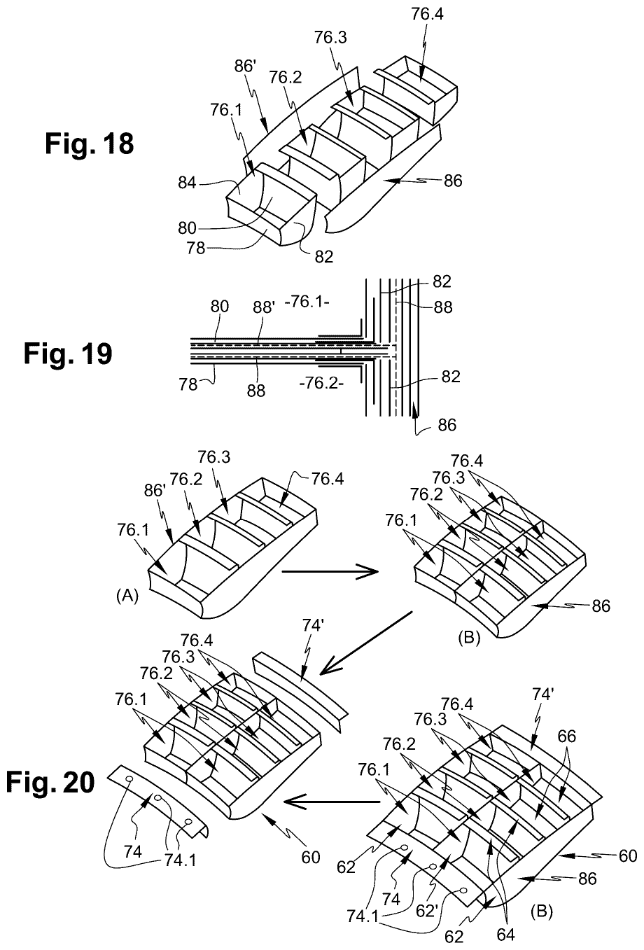

According to an embodiment visible in FIGS. 14 and 18, the method for obtaining a cascade of vanes comprises a step of manufacturing at least one longitudinal preform 86 forming a layer of a longitudinal wall 62 and a step of assembling the longitudinal preform 86 and the tubular preforms 76.1 to 76.4.

According to a first operating mode, visible in FIGS. 14 to 16, a longitudinal preform 86 is interposed between the first longitudinal facets 82 of a first row of tubular preforms and the second longitudinal facets 84 of a second row of tubular preforms. According to this first operating mode, a longitudinal wall 62 situated between two rows of vanes comprises the first longitudinal facets 82 of the first row of tubular preforms, the longitudinal preform 86 and the second longitudinal facets 84 of the second row of tubular preforms.

According to a second operating mode, visible in FIG. 18, first and second longitudinal preforms 86, 86′ are positioned on either side of a row of tubular preforms. According to this second operating mode, a longitudinal wall 62 comprises a longitudinal preform 86, 86′ and the first or second longitudinal facets 82, 84 of a row of tubular preforms.

According to this second operating mode, when two rows of vanes are assembled as illustrated in FIG. 20, the longitudinal wall 62 situated between the two rows of vanes comprises the first longitudinal facets 82 of the first row of tubular preforms, two longitudinal preforms 86, 86′, and the second longitudinal facets 84 of the second row of tubular preforms.

When the cascade of vanes 60 comprises at least one end plate 74, 74′, the method for obtaining a cascade of vanes comprises a step of manufacturing each end plate 74, 74′ and a step of assembling each end plate 74, 74′, consisting in connecting it with at least one tubular preform 76.1 to 76.4, as illustrated in FIG. 20.

Each of the tubular and longitudinal preforms 76.1 to 76.4, 86, 86′ is made of composite material and comprises fibers embedded in a matrix made of thermosetting or thermoplastic resin. Each end plate 74, 74′ is made of a composite material and comprises fibers embedded in a matrix made of thermosetting or thermoplastic resin. According to one configuration, the tubular preforms 76.1 to 76.4, the longitudinal preforms 86, 86′ and the end plates 74, 74′ are made of the same composite material.

When the tubular preforms 76.1 to 76.4 and any longitudinal preforms 86, 86′ and end plates 74, 74′ each comprise a matrix made of thermosetting resin, each assembly step consists in connecting the tubular preforms 76.1 to 76.4 and any longitudinal preforms 86, 86′ and end plates 74, 74′ by adhesive bonding or co-curing.

When the tubular preforms 76.1 to 76.4 and any longitudinal preforms 86, 86′ and end plates 74, 74′ each comprise a matrix made of thermoplastic resin, each assembly step consists in connecting the tubular preforms 76.1 to 76.4 and any longitudinal preforms 86, 86′ and end plates 74, 74′ by adhesive bonding, co-curing, co-consolidation or welding.

According to a first assembly mode, two tubular preforms 76.1, 76.2 are directly connected to each other, without any interposed element.

According to a second assembly mode, two tubular preforms 76.3, 76.4 (on the right in FIG. 16) are connected by at least one ply of adhesive 88.

According to a third assembly mode, two tubular preforms 76.1, 76.2 (on the left in FIG. 16) are connected by at least one ply of fibers 90 (impregnated with resin or non-impregnated) interposed between the two tubular preforms 76.1, 76.2. Plies of adhesive 88, 88′ may be interposed between the ply of fibers 90 and the tubular preforms 76.1, 76.2.

According to a fourth assembly mode, two tubular preforms 76.1, 76.3 are connected by at least one longitudinal preform 86. Plies of adhesive 88, 88′ may be interposed between the longitudinal preform 86 and the tubular preforms 76.1, 76.2.

The use of plies of adhesive 88 makes it possible to compensate for any roughnesses present on the surfaces of the tubular and longilinear preforms 76.1 to 76.4, 86, 86′ brought into contact during the assembly.

Of course, the invention is not limited to these assembly modes. The latter can be combined and possibly other assembly modes can be implemented.

According to a first operating mode, each tubular or longitudinal preform 76.1 to 76.4, 86, 86′ is partially cured or polymerized during the manufacturing step that comprises a partial curing or polymerization phase, a final curing or polymerization phase being carried out subsequently, at the latest during the assembly step.

According to a second operating mode, each tubular or longitudinal preform 76.1 to 76.4, 86, 86′ is completely cured or polymerized during the manufacturing step that comprises a phase of complete curing or polymerization of the tubular or longitudinal preform 76.1 to 76.4, 86, 86′.

According to one embodiment, the step of manufacturing the tubular preforms 76.1 to 76.4 comprises, for at least one tubular preform 76.1 to 76.4 and preferably all of them, at least one phase of compression of said tubular preform 76.1 to 76.4 and at least one curing or polymerization phase during which said tubular preform 76.1 to 76.4 is compressed and at least partially cured or polymerized.

According to one variant, the two compression and curing or polymerization phases are simultaneous. According to another variant, the curing or polymerization phase is completed before the end of the compression phase. According to this variant, the tubular preform 76.1 to 76.4 is compressed as long as the at least partial curing or polymerization has not been completed.

By way of example, during the compression and curing or polymerization phases, each tubular preform 76.1 to 76.4 is compressed at a pressure of between 2 and 7 bar and brought to a temperature of the order of 180° C. Of course, the invention is not limited to these pressures and this temperature. The latter vary as a function of the materials of the tubular preforms 76.1 to 76.4.

At the end of the manufacturing step, each tubular preform 76.1 to 76.4 is sufficiently cured or polymerized to maintain stable geometry and dimensions.

These compression and at least partial curing or polymerization phases make it possible to ensure the structural integrity of the cascade of vanes 60.

Prior to the compression phase, the step of manufacturing the tubular preforms 76.1 to 76.4 comprises, for at least one tubular preform 76.1 to 76.4, a draping phase during which plies of fibers 92 are positioned on or against at least one rigid mold 94 that has first, second, third and fourth inner faces F1 to F4 respectively shaped like the first transverse and longitudinal facets 78, 82 and the second transverse and longitudinal facets 80, 84. According to one embodiment, the mold 94 is tubular and made in one piece.

According to another embodiment, the mold 94 is tubular and comprises a plurality of parts 94.1 to 94.4, as illustrated in FIG. 13, which are configured to occupy assembled and disassembled states. This solution makes the demolding easier. According to one configuration, the mold 94 comprises four parts 94.1 to 94.4 each having one of the first, second, third and fourth inner faces F1 to F4.

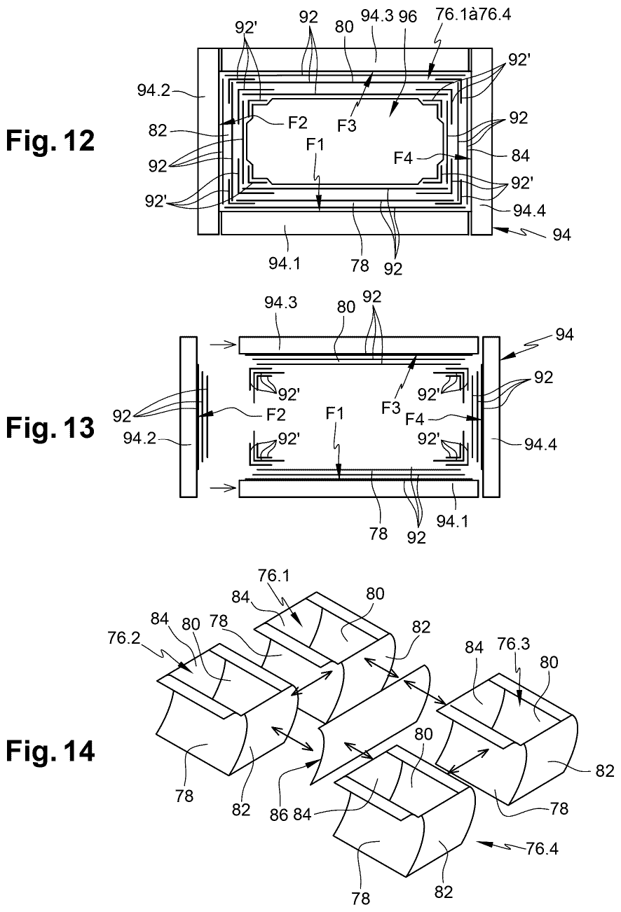

According to a first operating mode, visible in FIG. 12, the plies of fibers 92 are positioned on the first, second, third and fourth inner faces F1 to F4 when the mold 94 is assembled and has a tubular shape. According to this operating mode, first plies of fibers 92, each disposed only alongside one of the first, second, third and fourth inner faces F1 to F4, are positioned alternately with second, corner plies of fibers 92′ disposed straddling two inner faces among the first, second, third and fourth inner faces F1 to F4.

According to a second operating mode, visible in FIG. 13, the first plies of fibers 92 each disposed only alongside one of the first, second, third and fourth inner faces F1 to F4 are positioned when the parts 94.1 to 94.4 of the mold 94 are in the disassembled state. This solution makes it possible to simplify the putting in place of the first plies of fibers 92. According to this second operating mode, the second, corner plies of fibers 92′ are not put in place alternately with the first plies of fibers 92 and are added once the latter have been laid.

Of course, the invention is not limited to these operating modes for the putting in place of the plies of fibers 92, 92′.

According to an embodiment visible in FIG. 12, the compression phase consists in using at least one expandable element 96 configured to occupy retracted and expanded states, in positioning it in the retracted state between the various facets 78 to 84 of the tubular preform 76.1 to 76.4 positioned in the mold 94 and in expanding the expandable element 96 so as to compress said tubular preform 76.1 to 76.4. To this end, tooling for manufacturing the tubular preforms 76.1 to 76.4 comprises, in addition to the tubular mold 94, at least one expandable element 96 positioned in the mold 94 and configured to press the tubular preform 76.1 to 76.4 positioned in the mold 94 against the first, second, third and fourth inner faces F1 to F4 of the mold 94. According to one configuration, the expandable element 96 is an inflatable bladder.

The combination of the mold 94 and the expandable element 96 makes it possible, using simple tooling, to compress each tubular preform 76.1 to 76.4 effectively during the at least partial curing or polymerization phase, and this ensures structural integrity of each tubular preform 76.1 to 76.4.

In addition, as illustrated in FIG. 11, the manufacturing tooling may comprise a base 98 and a cover 100 that are positioned at the ends of the mold 94 so as to delimit with the latter a cavity.

Whatever the embodiment and the tooling used, dividing the cascade of vanes 60 into a multitude of tubular preforms 76.1 to 76.4, one for each cell 66, makes it possible to be able to manufacture each of them using relatively simple tooling while at the same time ensuring the structural integrity of each of them, and this makes it possible to obtain, after assembly of said preforms, a cascade of vanes that has excellent mechanical properties and vanes with, for at least some of them, a relatively great depth.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for obtaining a cascade of vanes of an aircraft thrust reversal device, said cascade of vanes having at least first and second longitudinal walls and vanes positioned between and connected to said first and second longitudinal walls, the first and second longitudinal walls and vanes of the cascade of vanes delimiting cells; wherein the method comprises:
a step of manufacturing at least first and second tubular preforms each having a first transverse facet forming at least one layer of a first vane, a second transverse facet forming at least one layer of a second vane, a first longitudinal facet forming at least one layer of a first longitudinal wall and a second longitudinal facet forming at least one layer of a second longitudinal wall; the first and second transverse facets and the first and second longitudinal facets forming a single piece and delimiting a cell,
a step of assembling the first and second tubular preforms, by connecting:
the first and second transverse facets of the first and second tubular preforms so as to form a common vane; or
the first and second longitudinal facets of the first and second tubular preforms so as to form a segment of a common longitudinal wall; or both.

2. The method as claimed in claim 1, wherein the step of manufacturing comprises, for at least one tubular preform, at least one phase of compression of said at least one tubular preform and at least one curing or polymerization phase during which said at least one tubular preform is compressed and at least partially cured or polymerized.

3. The method as claimed in claim 2, wherein, prior to the at least one phase of compression, the step of manufacturing comprises, for at least one tubular preform, a draping phase during which plies of fibers are positioned on or against at least one mold that has first, second, third, and fourth inner faces respectively shaped like the first transverse and longitudinal facets and the second transverse and longitudinal facets.

4. The method as claimed in claim 3, wherein the at least one phase of compression includes utilizing at least one expandable element configured to occupy a retracted state and an expanded state, and positioning the at least one expandable element in the retracted state between various facets of a tubular preform positioned in the mold and in expanding the expandable element so as to compress said at least one tubular preform.

5. The method as claimed in claim 3, wherein the plies of fibers are positioned on the first, second, third, and fourth inner faces when the mold has a tubular shape, by alternating first plies of fibers each disposed only alongside one of the first, second, third and fourth inner faces and second, corner plies of fibers disposed straddling two inner faces among the first, second, third and fourth inner faces.

6. The method as claimed in claim 3, wherein the mold comprises a plurality of parts configured to occupy an assembled state and a disassembled state, and
wherein first plies of fibers each disposed only alongside one of the first, second, third and fourth inner faces are positioned when the plurality of parts of the mold are in the disassembled state.

7. The method as claimed in claim 1, wherein the step of assembling comprises
pressing against one another and connecting the first and second transverse facets of the first and second tubular preforms so as to form a vane, and
aligning the first longitudinal facets of the first and second tubular preforms so as to form at least a part of the first longitudinal wall and the second transverse facets of the first and second tubular preforms so as to form at least a part of the first longitudinal wall.

8. The method as claimed in claim 1, wherein at least some vanes each comprise a body and a flange substantially perpendicular to the body, and
wherein the first transverse facet extends over at least a part of a vane at the body and the flange thereof, the second transverse facet extends over at least a second part of a vane at the body and the flange thereof, the first and second parts being complementary such that when assembled the first transverse facet of a first tubular preform and the second transverse facet of a second tubular preform form a complete vane.

9. The method as claimed in claim 1, further comprising:
a step of manufacturing at least one longitudinal preform forming a layer of a longitudinal wall; and
a step of assembling the longitudinal preform and the at least one tubular preform.

10. The method as claimed in claim 1, wherein two tubular preforms are connected by at least one ply of adhesive, or by at least one ply of fibers interposed between the two tubular preforms, or by both.

11. The method as claimed in claim 1, wherein, during the step of manufacturing, each tubular preform is partially cured or polymerized, a final curing or polymerization phase being carried out subsequently, at a latest during the step of assembling.

12. The method as claimed in claim 1, wherein, during the step of manufacturing, each tubular preform is completely cured or polymerized.

13. A cascade of vanes obtained using the method as claimed in claim 1.

14. An aircraft comprising:
at least one cascade of vanes as claimed in claim 13.
